(19) United States
(12) Patent Application Publication
(10) Pub. No.: US 2004/0184068 A1
(43) Pub. Date: Sep. 23, 2004

(54) Printer e-mail proxy

(76) Inventors: Brett Green, Meridian, ID (US); Linn Kropf, Boise, ID (US); Kram H. Allen, Meridian, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/390,221

(22) Filed: Mar. 17, 2003

(51) Int. Cl. G06F 3/12; G06F 13/00

(52) U.S. Cl. 358/1.15; 710/19

(57) ABSTRACT

A printer module receives a message from an attached printer that indicates a state of the printer, generates an e-mail message, the e-mail message indicating the state of the printer and an identifier identifying the printer, and sends the e-mail message via a network attachment to the computerized system.

### FIELD OF THE INVENTION

The invention relates generally to computer peripheral devices and e-mail, and more specifically to a system relating to an e-mail proxy for computer peripheral devices.

### BACKGROUND OF THE INVENTION

Printers typically print by depositing a consumable opaque substance on a page, such as toner deposited on a printed page in a laser printer or ink deposited on a printed page in an inkjet printer. Such consumables are replaced on a periodic basis as they are depleted, and are desirably user-replaceable or serviceable items. Laser printers, for example, typically have toner cartridges containing toner that a user can easily remove and replace. Similarly, inkjet printers typically have ink cartridges that a user can easily remove and replace.

Because printer users usually replace consumables such as toner cartridges, ink cartridges, and paper themselves, it is often up to the user of the printer to track the use of consumables, and to acquire replacement consumables when a printer's supply is depleted. In corporate office or other workplace settings, users typically do not replace the consumables in printers, but rely on a staff of Information Services (IS) support personnel to keep the printer consumables in a filled state to ensure availability of the printers. In such situations, the IS staff or others responsible for monitoring the state of printer consumables and keeping the consumables in an appropriate state will desirably have a method or system for monitoring the state of printers other than relying on user complaints to trigger replacement of depleted consumables.

One such system relies upon the printer's network connection to provide the printer the ability to generate and send via the network an e-mail alert on occurrence of depleted consumables, a paper jam, misconfiguration, or other event requiring IS staff intervention. Such a system would desirably generate an e-mail alert directed to the IS staff of other responsible party, indicating the particular problem with the printer and the printer's name or other identification. The IS staff are then able to monitor such devices by monitoring e-mail, and can quickly react to such problems as they occur.

Unfortunately, such a system requires relatively complex functionality within the printer, as well as a network connection attached to the printer. The printer must be able to generate and send an e-mail message and must be properly configured to do so, and cannot send e-mail over the network if the network connection has failed or if the computer is connected to a local computer such as via a parallel, firewire (IEEE 1384), Universal Serial Bus (USB), or other non-network connection.

### SUMMARY OF THE INVENTION

In one example embodiment of the present invention, a printer module executable on a computerized system is operable when executed to receive a message from an attached printer that indicates a state of the printer, to generate an e-mail message indicating both the state of the printer and an identifier identifying the printer, and to send the e-mail message via a network attachment to the computerized system.

### BRIEF DESCRIPTION OF THE FIGURES

FIG. 1 shows a printer and attached computer system consistent with one embodiment of the present invention.

FIG. 2 is a flowchart illustrating a method of practicing one embodiment of the present invention.

### DETAILED DESCRIPTION

In the following detailed description of sample embodiments of the invention, reference is made to the accompanying drawings that form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the scope of the present invention. The following detailed description is, therefore, not to be taken in a limiting sense, and the scope of the invention is defined only by the appended claims.

The present invention provides a printer module in some embodiments that when executed on a computerized system is operable to receive a message from an attached printer that indicates a state of the printer, to generate an e-mail message indicating both the state of the printer and an identifier identifying the printer, and to send the e-mail message via a network attachment to the computerized system. In further embodiments, the indicated state of the computerized system comprises at least one of a low toner condition, a low ink condition, a low paper condition, or a paper jam condition.

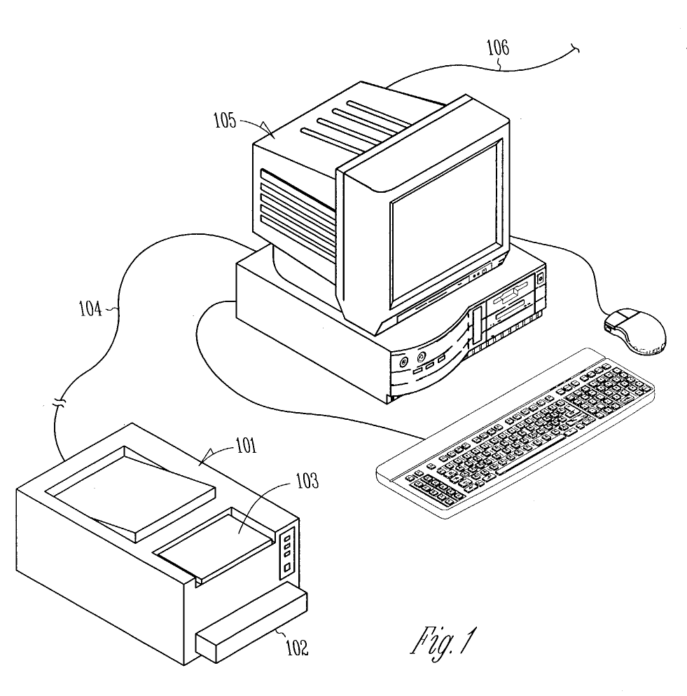

FIG. 1 shows an example system upon which some embodiments of the present invention may be practiced. A printer 101 uses various consumables to print, including paper 102 from a paper tray and toner from toner cartridge 103. Other printers may use other consumables, including other types of inks, dyes and toners, and may print on various media including transparencies, envelopes, special paper, and other media. These various printer types are generally susceptible to media jams or misfeeds, and typically have sensors within the various printer types that are operable to detect such jams.

The printer 101 is here connected via connection 104 to a computerized system 105. The connection 104 in various embodiments of the invention comprises any of various types of connection operable to provide communication between the computerized system and printer, including parallel (IEEE 1284), Universal Serial Bus (USB), firewire (IEEE 1384), and other such connections. The computerized system executes a software module consistent with an embodiment of the present invention, and is connected via a network connection 106 to a network over which e-mail may be sent.

In operation, the printer 101 monitors its status through various internal self-monitoring means and is operable to report its condition to computerized system 105. For example, the printer may detect via a sensor a low paper condition when it runs out of paper in one of its paper trays or runs out of other media in another tray, and will report the condition via connection 104 to the computerized system 105. Other conditions will be monitored in various embodiments of the invention, including monitoring paper jams or other media jams, monitoring configuration, monitoring use or workload, and monitoring other printer conditions and statistics. All these conditions and statistics will be reported in various embodiments of the invention to the computerized system 105 via connection 104.

Upon receipt of a message from the printer 101, such as a Printer Management Language (PML) message or other message, a printer module executing on the computerized system 105 receives the message and generates an e-mail message to a preconfigured e-mail address to notify the user of the e-mail address of the printer's state. In one embodiment of the invention, the computer system 105 sends the message via Simple Mail Transfer Protocol (SMTP), where the computer system has SMTP mail functionality but which is not within the printer's capability. This reduces the cost of the printer, and enables functionality already within the computer system to be utilized instead to provide virtual e-mail capability for the printer via the software module executing on the computerized system 105.

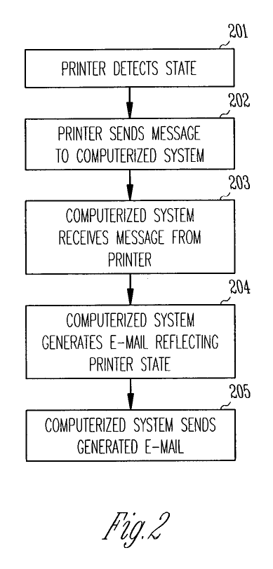

FIG. 2 is a flowchart, showing a method of practicing one embodiment of the present invention. At 201, a printer monitors its state and detects a certain state. In various embodiments, the detected state will include a low paper condition when the printer is low or out of paper, a low toner condition, a low ink condition, a paper jam condition, and any other such printer states of interest or that require attention.

The printer generates a message reflecting the detected state and sends the message to an attached computerized system at 202. In some embodiments of the invention, the printer is not network attached, but is attached via IEEE 1284 (parallel port connection), IEEE 1284.4, IEEE 1384 (firewire), USB (Universal Serial Bus), or other connection. In other embodiments, the printer is connected via another type of connection, such as an Ethernet connection, but may not have the capability to generate or send an e-mail message from within the printer.

Once the message is sent at 202, the computerized system can receive the message from the printer at 203. The received message may be encoded in a language such as Printer Management Language (PML), or encoded in any other way. After the computerized system has received the message, it creates an e-mail reflecting the printer's detected state at 204. This e-mail is then sent at 205 such as via the Simple Mail Transfer Protocol (SMTP) to an e-mail address such as a preconfigured e-mail address of a person responsible for maintaining the state of the printer.

In some embodiments of the invention, the printer is unable to generate or send e-mail itself, whether or not the printer is connected to a network, and so must rely upon a status message sent to another computerized system to cause the computerized system to generate and send an e-mail reflecting the detected status of the printer. In this way, the computerized system can use its e-mail capability as a proxy e-mail source for the printer without needing to incorporate e-mail functionality into the printer itself.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A printer module executable on a computerized system that when executed is operable to:
receive a message from an attached printer that indicates a state of the printer;
generate an e-mail message indicating the state of the printer and an identifier identifying the printer; and
send the e-mail message via a network attachment to the computerized system.

2. The printer module of claim 1, wherein the printer and computerized system are connected via a parallel port connection (IEEE 1284), a Universal Serial Bus (USB) connection, a firewire (IEEE 1384) connection, or an IEEE 1284.4 connection.

3. The printer module of claim 1, wherein the message from the attached printer is a Printer Management Language (PML) message.

4. The printer module of claim 1, wherein the generated e-mail message is sent to a preconfigured destination e-mail address associated with a person responsible for monitoring the state of the attached printer.

5. The printer module of claim 1, wherein the e-mail message is sent via the Simple Mail Transfer Protocol (SMTP) from the computerized system.

6. The printer module of claim 5, wherein the printer is attached to the computerized system via a network connection, but wherein the printer does not support the Simple Mail Transfer Protocol (SMTP) and so is unable to directly generate an SMTP message and send it via the network connection.

7. The printer module of claim 1, wherein the state of the printer comprises at least one of a low toner condition, a low ink condition, an low paper condition, and a paper jam condition.

8. A machine-readable medium with instructions encoded thereon, the instructions when executed operable to cause the computerized system to:
receive a message from an attached printer that indicates a state of the printer;
generate an e-mail message indicating the state of the printer and an identifier identifying the printer; and
send the e-mail message via a network attachment to the computerized system.

9. The machine-readable medium of claim 8, wherein the computerized system receives the message from the printer via a parallel port connection (IEEE 1284), or a Universal Serial Bus (USB) connection, a firewire (IEEE 1384) connection, or an IEEE 1284.4 connection.

10. The machine-readable medium of claim 8, wherein the message received from the attached printer is a Printer Management Language (PML) message.

11. The machine-readable medium of claim 8, wherein the sent e-mail message is sent to a preconfigured destination e-mail address associated with a person responsible for monitoring the state of the attached printer.

12. The machine-readable medium of claim 8, wherein the e-mail message is sent via the Simple Mail Transfer Protocol (SMTP) from the computerized system.

13. The machine-readable medium of claim 12, wherein the message is received from the printer via a network connection, but wherein the printer does not support the Simple Mail Transfer Protocol (SMTP) and so is unable to directly generate an SMTP message and send it via the network connection.

14. The machine-readable medium of claim 8, wherein the state of the printer comprises at least one of a low toner condition, a low ink condition, an low paper condition, and a paper jam condition.

15. A peripheral device module executable on a computerized system that when executed is operable to:
receive a message from an attached peripheral device that is not capable of sending an e-mail message, the received message indicating a state of the peripheral device;
generate an e-mail message indicating the state of the peripheral device and an identifier identifying the peripheral device; and
send the e-mail message via a network attachment to the computerized system.

16. A machine-readable medium with instructions encoded thereon, the instructions when executed operable to cause the computerized system to:
receive a message from an attached peripheral device that is not capable of sending an e-mail message, the received message indicating a state of the peripheral device;
generate an e-mail message indicating the state of the peripheral device and an identifier identifying the peripheral device; and
send the e-mail message via a network attachment to the computerized system.

17. A computer printer system, comprising:
a detection module within the printer operable to detect a state of the printer;
a messaging module within the printer operable to create a message indicating the detected state of the printer;
a communications module within the printer operable to communicate the message indicating the detected state of the printer to an attached computerized system; and
a machine-readable medium having instructions stored thereon that are executable on the attached computerized system and that when executed are operable to receive the message from the communications module, and to generate an e-mail message reflecting the message indicating the detected state of the printer and an identity of the printer to a preconfigured e-mail user.

18. The computer printer system of claim 1, wherein the state of the printer comprises at least one of a low toner condition, a low ink condition, an low paper condition, and a paper jam condition.

19. A computer peripheral device system, comprising:
a detection module within the peripheral device operable to detect a state of the printer;
a messaging module within the peripheral device operable to create a message indicating the detected state of the peripheral device;
a communications module within the peripheral device operable to communicate the message indicating the detected state of the peripheral device to an attached computerized system; and
a machine-readable medium having instructions stored thereon that are executable on the attached computerized system and that when executed are operable to receive the message from the communications module, and to generate an e-mail message reflecting the message indicating the detected state of the peripheral device and an identity of the peripheral device to a preconfigured e-mail user.

20. A method of managing a printer in a computerized system external to the printer, comprising:
receiving in the computerized system a message from the printer that indicates a state of the printer;
generating in the computerized system an e-mail message indicating the state of the printer and an identifier identifying the printer; and
sending from the computerized system the e-mail message via a network attachment to the computerized system.

21. A printer e-mail proxy system, comprising:
monitoring means operable to monitor the state of a remotely attached printer;
e-mail generating means operable to generate an e-mail message indicating the state of the printer and an identifier identifying the printer; and
e-mail sending means operable to send the e-mail message via a network attachment to the e-mail proxy system.
